(19) United States
(12) Patent Application Publication
(10) Pub. No.: US 2007/0128372 A1
(43) Pub. Date: Jun. 7, 2007

(54) Process and device for producing coated moldings

(75) Inventors: Jurgen Wirth, Koln (DE); Frank Berghahn, Konigswinter (DE); Wolfgang Pawlik, Koln (DE)

Correspondence Address: BAYER MATERIAL SCIENCE LLC, 100 BAYER ROAD, PITTSBURGH, PA, 15205, US

(73) Assignee: Hennecke GmbH

(21) Appl. No.: 11/633,287

(22) Filed: Dec. 4, 2006

(30) Foreign Application Priority Data
Dec. 7, 2005 (DE) 102005058292.3

(51) Int. Cl. B05D 1/02; B05C 5/00; B05C 11/00

(52) U.S. Cl. 427/421.1; 118/300; 118/58; 118/665; 118/712

(57) ABSTRACT

Molded articles comprising at least one layer of polyurethane are produced in a batch process by mixing polyurethane-forming components to form a reactive mixture that is flowed through a channel having at least one opening through which a gas is introduced and sprayed on a substrate surface. The device suitable for carrying out this batch process includes a cylindrical mixing chamber, a flow channel through which the reactive mixture flows and is sprayed onto the surface of a substrate where it cures thereon. The flow channel is cleaned by a stream of gas.

### BACKGROUND OF THE INVENTION

The present invention relates to a process and to a device for producing moldings made up of at least one layer of polyurethane.

When a reactive plastic material, for example, a polyurethane, is to be applied to a substrate over a large area, spraying has in most cases been the most suitable application technique.

Kunststoff-Handbuch, Volume 7 Polyurethane, 3rd Edition, 1993, published by Carl Hauser Verlag, describes various application examples of techniques for spraying a plastic onto a substrate: for example, coating the underside of a carpet by the spray method (Chapter 5.2.2.2). An agitating mixer head is generally used for mixing the reactive components. The finished reactive mixture is guided via a tube to a conventional spray nozzle, similar to that used for spraying surface coatings, which traverses transversely to the continuously moving carpet substrate and sprays the reactive mixture onto the substrate.

The chemical reaction then takes place by thermal activation. However, such a method is possible only with reactive mixtures that react slowly. With raw material systems that react quickly, the agitating mixer and the tube would clog and block the spray nozzle.

For that reason, so-called high-pressure mixers with miniaturized mixing chambers are used in the case of highly reactive raw material systems, in particular for batchwise operation. For example, when skin elements of a reactive plastic material are to be produced, special spray nozzles arranged downstream of the high-pressure mixers are used. An example of such a spray system is described in EP 0303 305 B1. Due to the relatively narrow and angular channels in the spray head, however, such systems tend to become blocked in time, in particular in the case of highly reactive raw material systems, and must therefore be cleaned from time to time. Although the problem can be alleviated in the case of high cycle frequency processes by alternately using two mixer heads, this requires a considerable additional outlay in terms of apparatus.

Further important criteria for an optimum spraying process and apparatus are lightweight, small spraying mixer heads which are able to spray as far as possible without producing aerosols or, at least, with minimal aerosol production.

Spraying mixer heads for batchwise operation are generally guided by a robot, which has to execute extremely rapid movements, so that a lightweight spraying mixer head is a great advantage.

The spraying mixer head also has to be small in the case of three-dimensional spray layers, in particular in the case of narrow depressions, in order to be able to reach the sloping surfaces in such narrow depressions.

During spraying, in addition to the spray droplets, which, as intended, reach the surface to be coated, it is also possible for aerosols (i.e., suspended particles) to form. Such aerosols reach surrounding equipment as a result of thermal currents or draughts and contaminate that equipment. Health risks to the workers also cannot be ruled out. For that reason, aerosols must be eliminated by complex and expensive suction and filter apparatus. However, not only are the additional investment costs for such apparatus high; the apparatus also requires continuous maintenance, which results in a high additional outlay in terms of labor.

Further disadvantages which cannot be disregarded arise from losses of raw materials themselves, because any aerosols that are drawn off and pass into the filter apparatus are lost from actual production.

### SUMMARY OF THE INVENTION

The object of the present invention was, therefore, to develop a batch process and a device for producing moldings made up of a layer of polyurethane. The device used for that purpose should (1) be small and easy to construct, (2) be capable of thorough mixing, (3) also be capable of spraying without aerosol production, or at least with minimal aerosol production, and (4) permit production without interruptions during operation. It should therefore be possible after each batch to clean the spraying mixer head so that no residue of reactive mixture remain anywhere in the spraying mixer head.

This and other objects which will be apparent to those skilled in the art are accomplished by combining the reactive components, mixing those components and applying the mixture to a substrate in the manner described more fully herein.

### BRIEF DESCRIPTION OF THE DRAWINGS

FIG. 1 is a diagram of a device suitable for carrying out the process of the present invention.

FIG. 2 illustrates the spraying mixer head component of the device of the present invention in the operating position.

FIG. 3 illustrates the spraying mixer head component of the device of the present invention in the cleaning position.

FIG. 4 is a diagram of a single sprayed strip with a wide aerosol edge produced by the process of the present invention.

FIG. 5 is a diagram of a single sprayed strip with a narrow aerosol edge produced by the process of the present invention.

FIG. 6 is a diagram of a single-layer spray application which is composed of individual sprayed strips with a narrow aerosol edge (as shown in FIG. 5).

### DETAILED DESCRIPTION OF THE PRESENT INVENTION

The present invention relates to a batch process for producing moldings made up of a layer of polyurethane, in which
a) the reactive components are first mixed in a cylindrical mixing chamber,
b) the reactive mixture so produced is then guided through an admission opening into a flow channel,
c) in the region of the admission opening, a stream of gas is additionally guided into the flow channel,
d) the reactive mixture leaving the flow channel is sprayed onto the surface of a substrate and cured thereon,
e) on completion of the batch, the mixing chamber is cleaned mechanically by moving an ejector which is movable axially in the mixing chamber, from the batch position into the cleaning position, and

f) the ejector is maintained in the cleaning position until both the end face of the ejector and the flow channel have been cleaned by the stream of gas.

The admission opening into the flow channel is preferably arranged substantially immediately behind the mixing chamber.

In the process of the present invention, the reactive components are first mixed in a mixing chamber by, for example, being mutually atomized by counter-current injection. The reactive mixture thus formed is then guided through a flow channel. In the entrance region of the flow channel, a stream of gas, e.g., air, is simultaneously pushed through the flow channel in addition to the stream of reactive mixture. The reactive mixture leaving the flow channel is then sprayed onto the surface of a substrate and cured thereon to produce composite moldings or sandwich components. Suitable substrates include fiber mats or a combination of fiber mats and spaced cores, such as paper honeycombs. It is also possible, however, for the substrate to be formed by the surface of a tool in order to produce a polyurethane component, for example a skin, directly. On completion of the batch, the mixing chamber is cleaned mechanically by means of an ejector, i.e., a cleaning plunger. The ejector is maintained in its cleaning position until both the end face of the ejector and the flow channel have been cleaned.

This method satisfies all of the criteria for an optimum spraying process.

The cylindrical shape of the mixer head is of simple construction and can therefore be small and lightweight, so that rapid movements and thus minimal cycle times are possible when spraying using a robot, for example. The small structural shape of the mixer head makes it maneuverable, so that uniform application of the mixture to form unbroken spray layers having a defined layer thickness is possible even with complex, three-dimensional components.

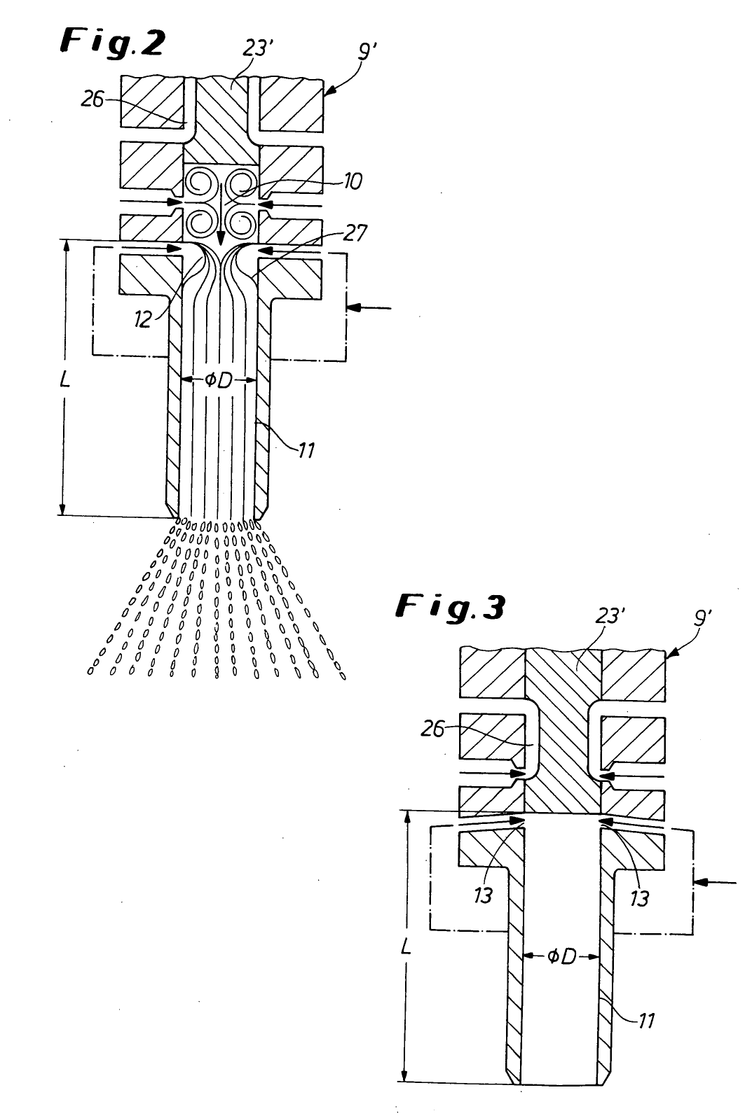

Because the stream of gas is introduced in the entrance region of the flow channel (i.e., into the plane immediately beneath the mixing zone), the mixing chamber can easily be divided into chambers. This is shown, for example, in FIG. 2. This also ensures that the reactive components are mixed perfectly.

The introduction of the stream of gas in the entrance region of the flow channel not only produces an outstanding mixing quality but also results in the reactive mixture disintegrating into droplets as it leaves the flow channel, thus effecting spraying. It is accordingly possible to dispense with the use of an additional spray nozzle.

On completion of the batch, the ejector moves forwards, thus cleaning the mixing chamber of reactive mixture completely. This can be seen, for example, in FIG. 3. It then remains in the forward position (cleaning position) for a short period of time of preferably from 0.1 to 10 seconds, more preferably from 0.5 to 5 seconds, during which the addition of gas is maintained, so that both the end face of the ejector and the flow channel are cleaned by the stream of gas. This configuration permits minimal cleaning times and accordingly also high cycle frequencies.

In a preferred variant of the present invention (FIG. 3), the inward flow of gas is directed at an angle against the end face of the ejector, which effects particularly good cleaning of this critical location.

During the cleaning operation, the inward flow of gas takes place preferably at a rate of from 50 m/s to 250 m/s. Because the consumption of gas is proportional to the flow rate, a relatively low flow rate of about 50 m/s is desirable for reasons of cost. In the case of highly reactive mixtures, however, it is necessary to increase the cleaning rate to 250 m/s, and accordingly also the amount of gas, in order to ensure the required cleaning effect.

In addition, the cleaning procedure comprising flushing with gas is preferably carried out rapidly and intermittently, in particular in the case of highly reactive raw material systems, in order further to accelerate the cleaning operation.

During production, the ratio of the mass of the stream of gas (\dot{m}_{G}) to the mass of the stream of the reactive mixture (\dot{m}_{R}) is preferably adjustable, preferably in a ratio \dot{m}_{G}/\dot{m}_{R} of from 2:1 to 1:100. When the ratio \dot{m}_{G}/\dot{m}_{R} is equal to 2:1 (i.e., a large amount of gas is used), a spray pattern with relatively fine spray droplets is obtained. When the ratio \dot{m}_{G}/\dot{m}_{R} is equal to 1:100 (i.e., a small amount of gas is used), a spray pattern with relatively coarse drops is obtained.

Although fine drops result in a very smooth spray surface, they produce a high aerosol content, which in turn requires an increased outlay in terms of removal by suction. Coarse drops produce a surface that is not so smooth, but they have only a minimal aerosol content. Using simple preliminary tests, the person skilled in the art can find the optimum between these extremes for the system being used (substrate, reactive components).

In a more preferred embodiment of the process of the present invention, the ratio \dot{m}_{G}/\dot{m}_{R} is also adjustable. There can be used as the controlled variable the form of the spray pattern, that is to say the width B of the sprayed strip that is produced and the width B′ characterising the part of the sprayed strip produced that has a uniform layer thickness.

An important parameter that influences the spray behavior is the diameter/length ratio D/L of the flow channel arranged downstream of the mixing chamber, a D/L ratio of from 1:1 to 1:50 preferably being established. A D/L ratio of about 1:1 results in relatively fine spray droplets, while a D/L ratio of about 1:50 produces relatively coarse spray drops.

The combination of the two measures, namely the choice of an optimum D/L ratio and the establishment or adjustment of the \dot{m}_{G}/\dot{m}_{R} ratio, provides a very broad spectrum of production conditions which ensure good mixing quality and which produce a spray pattern with a minimal aerosol content (see FIG. 5).

In order to establish optimum production conditions, the person skilled in the art can preferably proceed as follows:

A middle value of, for example, 1:20 is first chosen for the D/L ratio. The mass stream of gas \dot{m}_{G} is then increased, starting from a small stream of gas, until the mixing quality is perfect. The mass stream of gas \dot{m}_{G} is then increased further in order also to optimize the spray pattern, that is to say to establish a spray pattern without aerosols, or at least a spray pattern with a minimal aerosol content.

If the desired spray pattern is not optimum after this first procedure, the D/L ratio may be corrected in a further iteration step, namely by increasing the D/L ratio if the spray drops are too fine and lowering it if the spray drops are too coarse.

Of course, this iterative procedure generally has to be carried out only once, according to the particular application, and does not have to be repeated each time production is started.

Minimizing the aerosol content not only permits a minimal outlay in terms of removal by suction and minimal losses of raw materials but also permits spray applications with a minimal aerosol edge. This in turn allows the spray application to be carried out substantially in a single layer, that is to say in one pass, it being possible for adjacent sprayed strips to have a degree of overlap of preferably approximately from 1% to 40%, more preferably from 3% to 30%, most preferably from 5% to 20%, of the area sprayed per strip. That is, the width of the overlap between two adjacent sprayed strips of width B is preferably from 1 to 40% of the width B of a sprayed strip. With a degree of overlap of about 1%, a small depression can form between the sprayed strips because the amount of reactive mixture applied at the edges of the sprayed strips is generally smaller than in the middle. However, this depression evens out as the reactive mixture, which is still relatively liquid, runs. With a degree of overlap of about 40%, a small bump can form in the area in which the sprayed strips overlap, and this bump likewise evens out as the still relatively liquid reactive mixture runs.

The more reactive the mixture, the more precisely the degree of overlap must be established in order to obtain a completely flat surface, because there is less or scarcely any time for the mixture to run. Otherwise, slight unevenness has to be accepted.

It is generally the case, however, that a single-layer spray application has major advantages over a multi-layer spray application.

First, single-layer spray application results in a reduction in the spraying time and accordingly in a higher possible cycle frequency for production. Second, it is possible to use more highly reactive raw material systems. This in turn results in a saving in terms of time, because curing times are shorter. This is because the chemical reaction of the raw material system must proceed substantially more slowly with a multi-layer spray application in order to allow the production of a perfect “wet-on-wet” bond between the individual layers. With more highly reactive systems, however, there is an advantage in terms of quality in that, in the case of three-dimensional spray layers in particular, the sprayed layers can be prevented from running off the sloping surfaces, which is not possible with mixtures that react slowly.

The invention relates also to a device for producing moldings made up of at least one layer of polyurethane, which device includes
a) at least one storage container and metering unit for each reactive component,
b) a mixing component which includes a cylindrical mixing chamber and an ejector which is movable axially in the mixing chamber,
c) a connecting line from each metering unit to the mixing chamber,
d) a flow channel which is connected hydraulically to the mixing chamber via an admission opening with the diameter to length ratio D/L of the flow channel being from 1:1 to 1:50, and
e) at least one inlet opening, for supplying a stream of gas, which is arranged in the flow channel in the region of the admission opening.

The admission opening into the flow channel, through which the reactive mixture flows from the mixing chamber into the flow channel, is preferably arranged substantially behind the mixing chamber. The number of inlet openings for supplying the stream of gas varies but is preferably from two to twenty. Although two inlet openings for supplying the stream of gas have lower manufacturing costs than twenty inlet openings, twenty inlet openings effect substantially better division of the mixing zone into chambers, and accordingly a substantially better mixing quality. Also, the spray behavior of the mixer head and the cleaning of the end face of the ejector and of the flow channel are clearly better with twenty inlet openings for supplying the stream of gas than with two admission openings.

In a preferred embodiment of the device of the present invention, the cross-sectional area of the flow channel is smaller than the cross-sectional area of the mixing chamber. It is thus possible to influence the mixing behavior in the mixing chamber, because the division of the mixing zone into chambers by the addition of gas is additionally assisted thereby. A disadvantage, however, is that the bandwidth of the spray drop spectrum that can be established is reduced, so that a ratio of mixing chamber cross-section to flow channel cross-section of, for example, 10 is expedient only in the case of raw material systems that are extremely difficult to mix.

The disadvantageous effect of a reduction in the cross-section of the flow channel relative to the cross-section of the mixing chamber can partly be compensated for if the transition from the mixing chamber to the flow channel is conical, in particular, if the flow channel is conical over its entire length.

The flow channel arranged downstream of the mixing zone is preferably replaceable.

In order to be able to adjust the mass stream of gas, a control member, e.g., a control valve, is preferably integrated into the gas feed line.

In a further preferred embodiment of the device, it is also possible to detect the spray pattern by means of a sensor. Suitable sensors include optical devices, for example those with incident-light-reflection measurement or those with color or light/dark detection.

With a control member for the mass stream of gas \dot{m}_{G} and a sensor for detecting the spray pattern, and a control system governing these two members, optimal adjustment of the spray pattern, and accordingly of the spraying process, during ongoing production is possible.

The invention is explained in greater detail with reference to the Figures.

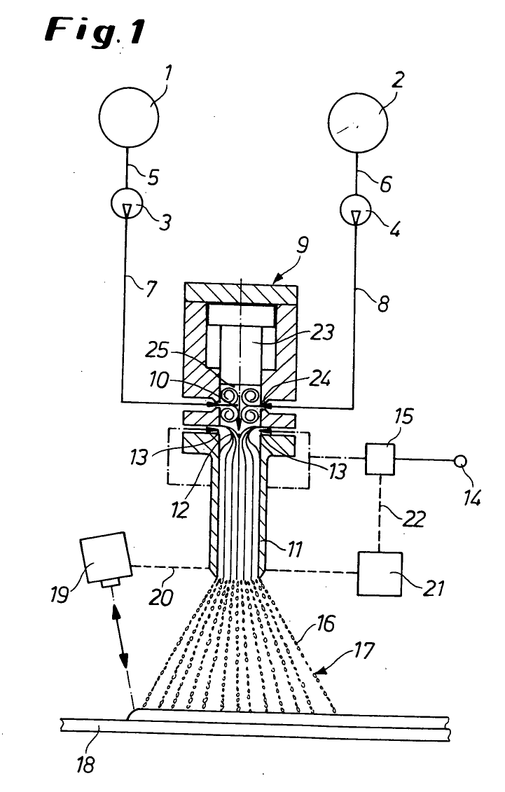

FIG. 1 shows a simplified diagram of a device according to the invention for carrying out the process of the present invention. In this device, the reactive polyol and isocyanate components are each fed from their respective storage containers 1, 2 by means of metering units, for example metering pumps 3, 4, via suction lines 5, 6 and high-pressure lines 7, 8 to the high-pressure spraying mixer head 9, where they are mutually atomized by means of counter-current injection and are thereby mixed. Immediately behind the mixing chamber 10, which forms the mixing zone, there is a flow channel 11. In the region of the admission opening 12 into the flow channel 11 there are arranged inlet openings 13 for supplying a stream of gas, through which a gas such as air is blown into the flow channel 11. In this manner, the reactive mixture flowing out of the mixing chamber 10 is constricted. As a result, so-called division of the mixing zone into chambers takes place, so that the reactive components are mixed thoroughly with one another.

The gas is fed from a gas source 14 via a control valve 15 by means of gas lines to the inlet openings 13 for supplying the stream of gas. The reactive mixture and the stream of gas then flow together through the flow channel 11 arranged downstream of the mixing chamber 10 in the direction of flow.

After leaving the flow channel 11, the reactive mixture disintegrates into individual droplets 16, while the gas escapes into the surrounding atmosphere, whereby it expands and thereby widens the mixture spray stream 17. The spray stream 17 is sprayed onto the substrate 18 strip by strip, resulting in a uniform spray layer.

A sensor 19 detects the so-called spray pattern from the side and transmits the determined data to the control device 21 via the corresponding pulse line 20. If the determined spray pattern differs from a desired value, the amount of gas can be changed correspondingly by means of the control valve 15. To that end, a reference spray pattern is stored in the control device 21 for comparison purposes. The required change is then transmitted via the associated pulse line 22 between the control device 21 and the control valve 15.

Preferably, the data, that is to say the throughputs of the metering units 3, 5, can also be fed into the control device 21. (The pulse lines required therefor are not shown in FIG. 1.) This is expedient because different spray patterns must also be stored for different discharge amounts.

Immediately after completion of the batch, the ejector 23 (a cleaning plunger arranged in an axially movable manner in the mixing chamber 10) moves downwards, closes off the nozzles 24 for atomizing the reactive components into the mixing chamber 10, and at the same time cleans the mixing chamber 10 of reactive mixture.

In the example in FIG. 1, the mass stream of gas can be switched from production operation to cleaning operation, the control valve 15 then opening further and thus allowing through the amount of gas required for cleaning the end face 25 of the ejector 23 and the flow channel 11. When cleaning is complete, the ejector 23 is moved upwards again and the control valve 15 is switched to production operation again, so that the next batch can then be carried out.

FIG. 2 shows a component of the device according to the invention, the high-pressure spraying mixer head 9′, in the batch position. FIG. 2 is intended to show the substantial constriction of the stream of reactive mixture (indicated by flow lines 27). The constriction has the effect that the cross-section through which the reactive mixture flows from the mixing chamber 10 is narrowed in the region of the admission opening 12 into the flow channel 11, as a result of which the mixing chamber 10 acquires an additional limitation in this region effected by the stream of gas.

FIG. 2 also shows the length L and the diameter D of the flow channel 11. The spraying mixer head 9′ in FIG. 2 differs from the spraying mixer head 9 shown in FIG. 1 only by a different construction of the ejector 23′, which in FIG. 2 also contains control grooves 26 with which the reactive components polyol and isocyanate can be switched from batchwise operation (as shown in FIG. 2) to cleaning or recirculating operation (as shown in FIG. 3). This has the advantage that, especially after stoppages, the reactive components are always available in a constant condition, for example at a constant temperature. In order to achieve the same effect with the high-pressure spraying mixer head 9 shown in FIG. 1, the temperatures of the lines would have to be controlled separately, for example by associated heating means (not shown in FIG. 1).

The spirals shown diagrammatically in the mixing chamber 10 are intended to represent the mixing operation.

FIG. 3 shows the same high-pressure spraying mixer head 9′ as shown in FIG. 2. In FIG. 3, however, the high-pressure spraying mixer head 9′ is in cleaning operation, during which the reactive components recirculate through the control grooves 26.

In the embodiment shown in FIG. 3, the inlet openings 13 for supplying a stream of gas are directed at an angle against the end face of the ejector 23′, which effects particularly good cleaning of this critical location and is expedient especially in the case of raw material systems that are highly adhesive.

In the case of highly reactive raw material systems in particular, cleaning by the stream of gas preferably takes place rapidly and intermittently.

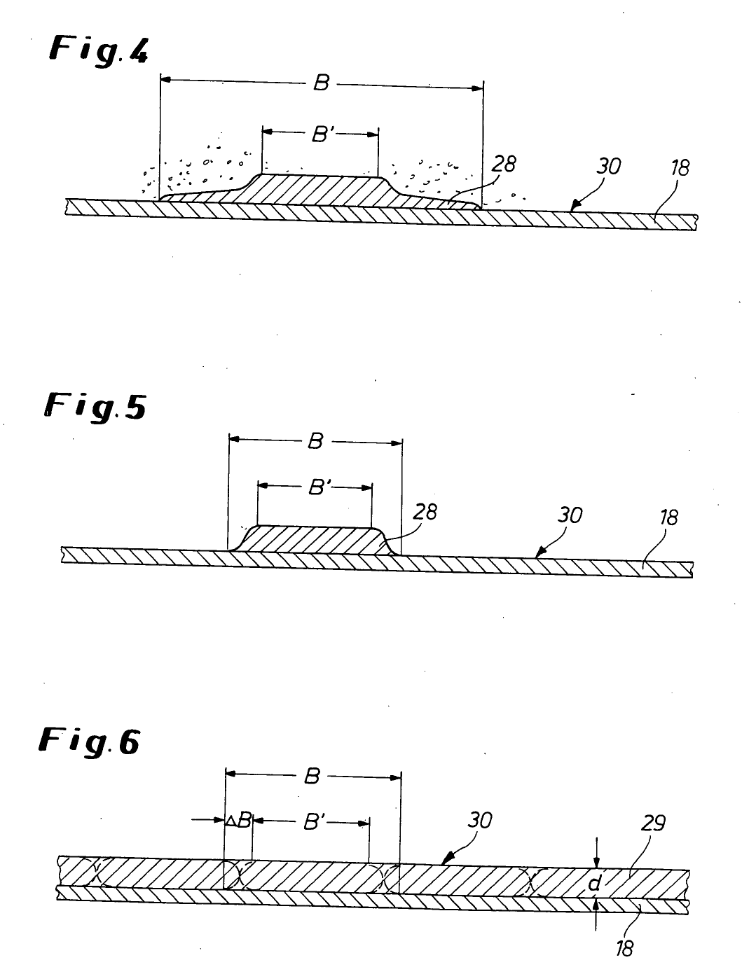

FIG. 4 shows, in diagrammatic form, a molding 30 made up of a sprayed strip 28 with a wide aerosol edge, which has been applied to a substrate 18. The wide aerosol edge occurs especially when a large number of aerosols form during the spraying operation. The sprayed strip 26 is characterised by its width B. The width B′ denotes the part of the sprayed strip that has a uniform layer thickness and accordingly does not belong to the aerosol edge. The application direction for the sprayed strip shown in FIG. 4 is perpendicular to the plane of the drawing.

FIG. 5 shows, in diagrammatic form, a molding 30 made up of a sprayed strip 28 with a narrow aerosol edge, which has been applied to a substrate 18. The narrow aerosol edge occurs especially when the aerosol content is minimized during the spraying operation. In FIG. 5, the sprayed strip 28 is again characterised by its width B. The width B′ denotes the part of the sprayed strip that has a uniform layer thickness and accordingly does not belong to the aerosol edge. The application direction for the sprayed strip shown in FIG. 5 is perpendicular to the plane of the drawing.

FIG. 6 shows, in diagrammatic form, a molding 30 made up of a single-layer spray layer 29 which has been applied to a substrate 18. The spray layer 29 is composed of a plurality of sprayed strips having narrow aerosol edges (as shown in FIG. 5). With optimum overlapping of the sprayed strips, an almost flat surface can be obtained. That is possible in particular with minimized or narrow aerosol edges. In addition to the width B of the sprayed strip, the width B′ is also indicated, namely the width of the middle portion of the sprayed strip having a uniform layer thickness d. The overlap ΔB between two sprayed strips is accordingly

$$Δ B = \frac{B - {B}^{′}}{2} ,$$

and the degree of overlap in percent is:

$$\frac{Δ B}{B} 100 \% .$$

The thickness d is shown on an enlarged scale in the diagram, and the widths B and B′ are shown on a reduced scale.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A batch process for producing moldings comprising a layer of polyurethane on a substrate comprising:
a) mixing reactive polyurethane-forming components in a cylindrical mixing chamber to form a batch of a reactive mixture,
b) guiding the reactive mixture from the mixing chamber to the substrate through an admission opening into a flow channel,
c) guiding a stream of gas from the region of the admission opening into the flow channel,
d) spraying the reactive mixture leaving the flow channel onto the surface of the substrate,
e) allowing the reactive mixture on the surface of the substrate to cure,
f) mechanically cleaning the mixing chamber by moving an ejector which is movable axially in the mixing chamber from batch position into cleaning position when spraying of the batch has been completed, and
g) maintaining the ejector in the cleaning position until both the ejector's end face and the flow channel have been cleaned by the stream of gas.

2. The process of claim 1 in which the stream of gas flows into the flow channel at a rate of from 50 to 250 m/s.

3. The process of claim 1 in which the stream of gas flows into the flow channel at a rate of from 75 to 200 m/s.

4. The process of claim 1 in which the stream of gas flows into the flow channel at a rate of from 100 to 150 m/s.

5. The process of claim 1 in which the ratio of the mass streams of gas and reactive mixture \dot{m}_{G}/\dot{m}_{R} is set between 2:1 and 1:100.

6. The process of claim 1 in which the ratio of the mass streams of gas and reactive mixture \dot{m}_{G}/\dot{m}_{R} is set between 1:1 and 1:75.

7. The process of claim 1 in which the ratio of the mass streams of gas and reactive mixture \dot{m}_{G}/\dot{m}_{R} is set between 1:2 and 1:50.

8. The process of claim 5 in which the ratio \dot{m}_{G}/\dot{m}_{R} is adjustable.

9. The process of claim 1 in which the flow channel has a ratio of diameter to length of from 1:1 to 1:50.

10. The process of claim 1 in which the flow channel has a ratio of diameter to length of from 1:2 to 1:30.

11. The process of claim 1 in which the flow channel has a ratio of diameter to length of from 1:3 to 1:10.

12. The process of claim 1 in which the reactive mixture is sprayed substantially in a single layer with adjacent sprayed strips having a degree of overlap of from 1% to 40%.

13. The process of claim 1 in which the reactive mixture is sprayed substantially in a single layer with adjacent sprayed strips having a degree of overlap of from 3% to 30%.

14. The process of claim 1 in which the reactive mixture is sprayed substantially in a single layer with adjacent sprayed strips having a degree of overlap of from 5% to 20%.

15. A device for producing moldings comprising a layer of polyurethane which device comprises
a) a storage container for each reactive component,
b) a metering unit for each reactive component,
c) a mixing member comprising
(1) a cylindrical mixing chamber and
(2) an ejector which is movable axially in the mixing chamber,
d) a connecting line from the metering unit for each reactive component to the mixing chamber,
e) a flow channel which is connected hydraulically to the mixing chamber by means of an admission opening, which flow channel has diameter to length ratio of from 1:1 to 1:50, and
f) at least one inlet opening in the flow channel which is in the region of the admission opening for supplying a stream of gas.

16. The device of claim 15 in which the admission opening into the flow channel is arranged substantially immediately behind the mixing chamber.

17. The device of claim 15 in there are from two to twenty inlet openings in the flow channel for supplying a stream of gas.

18. The device of claim 15 in which there are from three to sixteen inlet openings in the flow channel for supplying a stream of gas.

19. The device of claim 15 in there are from four to eight inlet openings in the flow channel for supplying a stream of gas.

20. The device of claim 15 having a ratio of cross-sectional area of the mixing chamber to cross-sectional area of the flow channel of from 1.05 to 10.

21. The device of claim 15 having a ratio of cross-sectional area of the mixing chamber to cross-sectional area of the flow channel of from 1.1 to 5.

22. The device of claim 15 having a ratio of cross-sectional area of the mixing chamber to cross-sectional area of the flow channel of from 1.2 to 2.

23. The device of claim 15 having a transition from the mixing chamber to the flow channel in conical form.

24. The device of claim 15 in which the flow channel is in conical form over its entire length.

25. The device of claim 15 which further comprises a control member for changing mass flow of the gas.

26. The device of claim 15 which further comprises a sensor for detecting spray pattern.

27. The device of claim 15 which further comprises a control device for adjusting mass flow of gas based on detected spray pattern.
